(19) United States
(12) Patent Application Publication
(10) Pub. No.: US 2007/0263089 A1
(43) Pub. Date: Nov. 15, 2007

(54) Video recording system-equipped golf cart

(76) Inventor: Mikol Hess, Hastings, NE (US)

Correspondence Address: Law Offices of Adam H. Jacobs;Patent Attorney, Suite 726, 1904 Farm Street, Omaha, NE, 68102, US

(21) Appl. No.: 11/434,350

(22) Filed: May 15, 2006

(51) Int. Cl. H04N 7/18

(52) U.S. Cl. 348/148; 348/157

(57) ABSTRACT

A video recording system-equipped golf cart includes a golf cart having at least a releasably locking brake pedal operatively connected to brakes to secure the golf cart in a stopped position. A video recording system includes a digital video camera mounted on the golf cart and facing outwards therefrom and a digital video recorder mounted on the golf cart and connected to the camera. A programmable logic controller device is in information transmission connection with the digital video recorder and a brake pedal sensor on the golf cart and is operative to initiate operation of the digital video recorder upon the brake pedal being locked to secure the golf cart in a stopped position and is further operative to prevent operation of the digital video recorder upon the brake pedal being released from locked position whereby the digital video recorder is inoperative when the golf cart is not stopped.

### BACKGROUND OF THE INVENTION

1. Technical Field

The present invention is directed to portable video recording devices and, more particularly, to a video recording system-equipped golf cart which includes a golf cart having the standard golf cart equipment thereon, including a releasably locking brake pedal device which is lockable to secure the golf cart in a stopped position and a video recording system which includes a digital video camera mounted on the golf cart, a digital video recorder mounted on the golf cart which receives and records video images from the digital video camera on recordable digital media within the digital video recording device, a programmable logic controller device in information transmission connection with the digital video recording device and the brake pedal of the golf cart, the programmable logic controller device operative to initiate operation of the digital video recorder upon the brake pedal being locked to secure the golf cart in a stopped position and being further operative to prevent operation of the digital video recorder upon the brake pedal being released from locked position whereby the digital video recorder is inoperative when the golf cart is not stopped and a power supply for supplying power to each of the elements of the video recording system such that the video recording system can record the actual golf shots being taken by a player during a round of golf and store those video images for future playback or review to enhance and assist training for golfers using the video recording system of the present invention.

2. Description of the Prior Art

One of the most effective ways by which a golfer may improve his or her golf skills is to take a lesson or a series of lessons from a teaching professional. The one-on-one interaction between the golfer and the teaching professional will almost invariably lead to significant improvements in the golfer's ability and confidence level, and it has been shown time and again that such a teaching experience provides far more benefits than equipment changes or other such cosmetic modifications. In general, the teaching professional would work with the golfer on the driving range and have the golfer hit a number of shots on the driving range, with instruction being given between the shots taken to eliminate poor or flawed techniques and enhance good, technically sound ball-striking habits. One of the significant drawbacks, however, of the standard golf lesson is that all of this teaching takes place in virtually ideal conditions, on a level surface (i.e. the driving range) without any pressures or time constraints between shots. This often results in the teachings learned by the golfer being forgotten or corrupted when he or she is actually playing a round of golf. While the ideal situation would permit the teaching professional to accompany the golfer during the course of the round of golf, for all but a very few individuals, this is impractical due to time and money constraints and simply will not happen. There is therefore a need for a system which will permit the teaching professional to see how the golfer is adapting and reacting to actual play situations and utilize that information to adjust or tailor the teaching techniques to be applied to that particular golfer.

One possible solution would be to videotape the entire round of golf played by the golfer and then bring the videotape back to the teaching professional for review thereof. While it may be possible to videotape every golf shot of the individual from a technical standpoint, this again is impractical as it requires another person to ride along in the golf cart or walk with the individual on the golf course while carrying the video camera equipment. Also, it will likely be necessary for the individual carrying the video camera to bring along a tripod or other such camera stand to ensure that the video images recorded by the camera are of sufficient quality to permit the teaching professional to review the video and determine the nature of the swing flaws which need to be corrected for the golfer. However, the most important reason why this procedure is impractical is that it will in all likelihood significantly slow the pace of play, thus causing backups on the golf course, which are the golf course's bane, even without persons attempting to videotape each and every one of their shots. There is therefore a need for a video recording system which will provide stable high-quality images for review by the teaching professional yet also will not slow the pace of play for the golfer.

Several prior art devices have been proposed for use in connection with videotaping of real golf play, including Wilkins, Jr., U.S. Pat. No. 6,142,437, but invariably the prior art devices are merely stands and mounting devices which permit a video camera to be mounted on a golf cart for the purpose of recording a round of golf. While this eliminates the stability problem encountered with hand-held video cameras, it does not eliminate the problem of increased playing time which slows down other golfers on the course. Also, inventions such as Wilkins, Jr., do not solve the additional problem encountered in the use of such video taping devices, and that is that the video taping device can be used for other purposes than only for the videotaping of the golfer's swing. Specifically, in inventions such as that shown in Wilkins, Jr., the video camera may be used during movement of the golf cart, as the video camera is an independent unit merely mounted on the golf cart, and thus the golf course and golf course staff retain little control over the actual use of the video camera. While this will not present a problem with the majority of golfers, there will always be a certain number of golfers who will be inclined to use the video camera for inappropriate purposes, and as control and access to the videotape is not restricted, those persons may then access the video and use it for their own purposes. There is therefore a need for a video recording system for use by golfers which is integrated into the operation of the golf cart and which incorporates additional safeguards to attempt to prevent unauthorized usage of the video recording system for inappropriate purposes.

Finally, one of the significant disadvantages of video cameras used for filming of a golfer's round of golf is that they generally require at least some degree of attentiveness to properly operate the device to obtain a video record of the round of golf. Specifically, this may involve properly aiming the camera, beginning recording of the golf shot by activating the video camera to record the golf shot and then turning off the video camera when the golf shot is completed. This will likely result in the golfer thinking about numerous extraneous things instead of focusing on what he or she should be thinking about, which are the instructions given to him or her by the teaching professional to improve their golf skills. There is therefore a need for a video recording system for use by golfers which will require virtually no setup or operational input from the golfer during the round of golf yet will still produce high-quality video images of the round of golf to be used by the teaching professional for review of the round of golf and to provide the teaching professional with the information necessary to address and correct the golfer's flaws.

Therefore, an object of the present invention is to provide a video recording system-equipped golf cart.

Another object of the present invention is to provide a video recording system-equipped golf cart which includes a standard golf cart which includes at least a releasably locking brake pedal which is releasably lockable to secure the golf cart in a stopped position and a video recording system which includes a digital video camera mounted on the golf cart and facing outwards therefrom, a digital video recorder mounted on the golf cart in connection with the digital video camera, a power device such as a battery and converter for powering the digital video camera and digital video recorder and a programmable logic controller in information transmission connection with the digital video recording device and the brake pedal of the golf cart which is operative to initiate operation of the digital video recorder upon the brake pedal being locked to secure the golf cart in a stopped position and which is further operative to prevent operation of the digital video recorder upon the brake pedal being released from locked position whereby the digital video recorder system is inoperative when the golf cart is not stopped.

Another object of the present invention is to provide a video recording system-equipped golf cart which can obtain a video image record of the golfer's swings and shots for future playback and review of the video image record to enhance and assist training for golfers via the teaching professional.

Another object of the present invention is to provide a video recording system-equipped golf cart which requires the golfer merely to park the cart in a position aiming the video camera at the location of the golf ball, engage the parking brake of the golf cart, select a club, approach the ball, hit the ball, return to the cart and drive on while simultaneously obtaining a video record of the golf shot via the video recording system, thus virtually eliminating slowing of the pace of play due to the video recording of the golf shots and allowing the golfer to concentrate on the round of golf.

Another object of the present invention is to provide a video recording system-equipped golf cart which includes a simple and efficient method by which transfer of the video images can be accomplished, whether it is by transfer of a flash card from the digital video recording device or by wireless upload of the video data to a viewing location where the teaching professional can quickly and easily access and review the video obtained by the video recording system-equipped golf cart.

Finally, an object of the present invention is to provide a video recording system-equipped golf cart which is relatively simple and durable in design and construction and is safe, efficient, and effective in use.

### SUMMARY OF THE INVENTION

The present invention provides a video recording system-equipped golf cart which includes a golf cart having at least a chassis, ground-engaging wheels rotatably mounted on the chassis, a body mounted on the chassis, an engine operative to power the golf cart, a steering device operatively connected to the ground-engaging wheels, and a releasably locking brake pedal mounted on the golf cart and operatively connected to brakes which engage the ground-engaging wheels to slow the golf cart and which is then releasably lockable to secure the golf cart in a stopped position. A video recording system is also included which has a digital video camera mounted on the golf cart and facing outwards therefrom, the digital video camera operative to receive video images therein, and a digital video recorder mounted on the golf cart, the digital video recorder operative to receive and record video images on recordable digital media therein. The digital video recorder is in information transmission connection with the digital video camera for transfer of video images therefrom, and a programmable logic controller device is in information transmission connection with the digital video recorder and a brake pedal sensor on the golf cart. The programmable logic controller device is operative to initiate operation of the digital video recorder upon the brake pedal being locked to secure the golf cart in a stopped position and is further operative to prevent operation of the digital video recorder upon the brake pedal being released from locked position whereby the digital video recorder is inoperative when the golf cart is not stopped. A power supply is connected in power transmission connection with the various elements of the video recording system, and finally the video recording system is operative to obtain a video image record of event occurrences around the golf cart including the golf player's swings and shots for future playback and review of the video image record to allow a teaching professional to review the video image record to enhance and assist training for golfers using the video recording system-equipped golf cart of the present invention.

It is thus seen that the present invention provides a novel system by which video recordings of actual golf play situations can be made. For example, because the video camera is mounted on the golf cart facing outwards therefrom, it is a simple matter for the user of the present invention to line up the video camera so that it is aiming at the location of his or her golf ball, then by engaging the parking brake of the golf cart, activate the video recorder to record the golf shot without requiring additional orientation or operational input. The user would then merely return to the cart, disengage the parking brake thus stopping the video recorder from recording additional video images, and proceed to the next golf shot, where the same procedure would again be followed. Contrast this with the various devices found in the prior art, which require the user to properly orient the video camera to record the golf shot, engage the video camera to begin recording video images, quickly proceed to hitting the golf shot to keep to a minimum the amount of video tape expended in recording the golf shot, return to the cart and turn off the video camera, then proceed to the next shot having spent little if any time focusing on the mechanics of properly executing the golf shot due to the operational requirements of the prior art recording devices. An additional improvement found in the present invention which is not found in the prior art is that the video recording device is prevented from operating unless the vehicle is stopped and the parking brake is engaged. This will help to prevent unauthorized filming of inappropriate subject matter, a feature which is amplified by the fact that the video camera of the present invention is fixedly mounted on the golf cart to prevent rotation or alternate orientation of the video camera. This significantly limits the potential for unauthorized use of the video recording system of the present invention, which presents a substantial improvement over many of the video recording devices found in the prior art. It is therefore seen that the present invention provides a substantial improvement over those video recording devices found in the prior art.

### BRIEF DESCRIPTION OF THE DRAWINGS

FIG. 1 is a perspective view of the video recording system-equipped golf cart of the present invention;

FIG. 2 is a perspective view of the video recording system-equipped golf cart of the present invention being used to record the video of a golf shot;

FIG. 3 is a detail perspective view of the elements of the video recording system of the present invention;

FIG. 4 is a schematic diagram of the video recording system showing the connections of the elements to one another;

FIG. 5 is a detail side elevational view of the video camera mounted on the roof of the golf cart; and

FIG. 6 is a detail side elevational view of the mounting bracket used to mount the digital video recorder on the golf cart.

### DESCRIPTION OF THE PREFERRED EMBODIMENT

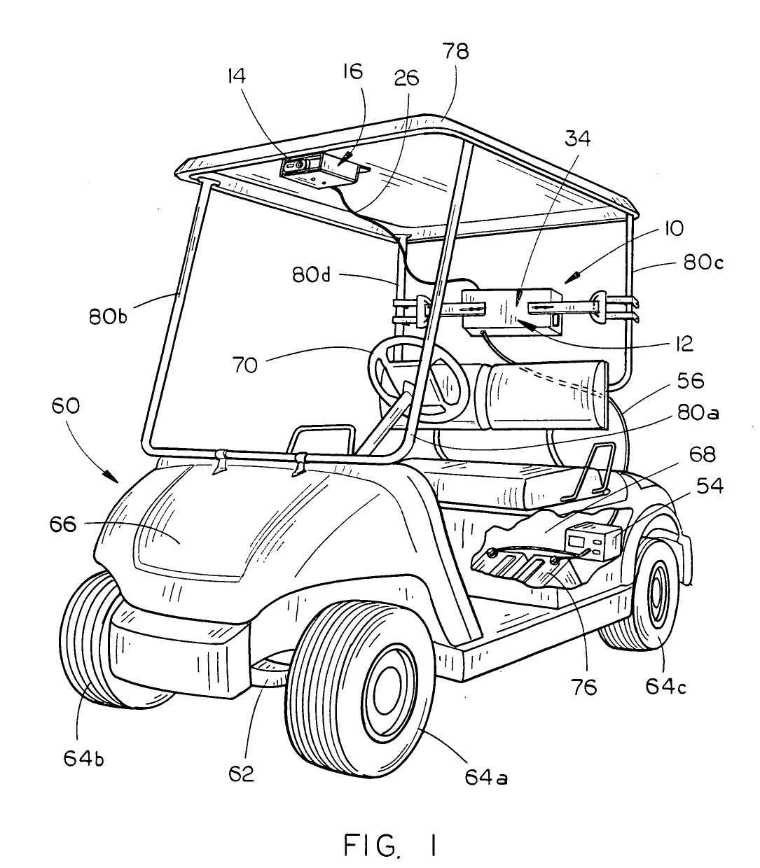

The video recording system-equipped golf cart 10 of the present invention is shown best in FIGS. 1-4 as including two main elements, the first being a standard-type golf cart 60 and the second being the video recording system 12 itself which is mounted on the golf cart 60. The golf cart 60 would preferably include a chassis 62, ground-engaging wheels 64a, 64b, 64c, and 64d rotatably mounted on the chassis 62, a molded plastic or fiberglass body 66 mounted on the chassis 62 and an engine 68 operative to power the golf cart 60. A steering wheel 70 is operatively connected to the ground-engaging wheels 64a and 64b for steering the golf cart 60, and the golf cart 60 would further include a releasably locking brake pedal 72 which includes a parking brake engagement section 74 which operates to lock brake pedal 72 in a depressed position to engage the brakes of the golf cart 60 to lock the ground-engaging wheels 64a-d to prevent forward or rearward motion of the golf cart 60. Each of the above-described elements are generally standard features of a golf cart, but for purposes of the present invention, the most significant and important element is the brake pedal 72 having the parking brake engagement section 74 which releasably locks the brake pedal 72 in a depressed position to engage the brakes. The importance of this element will be described later in this disclosure.

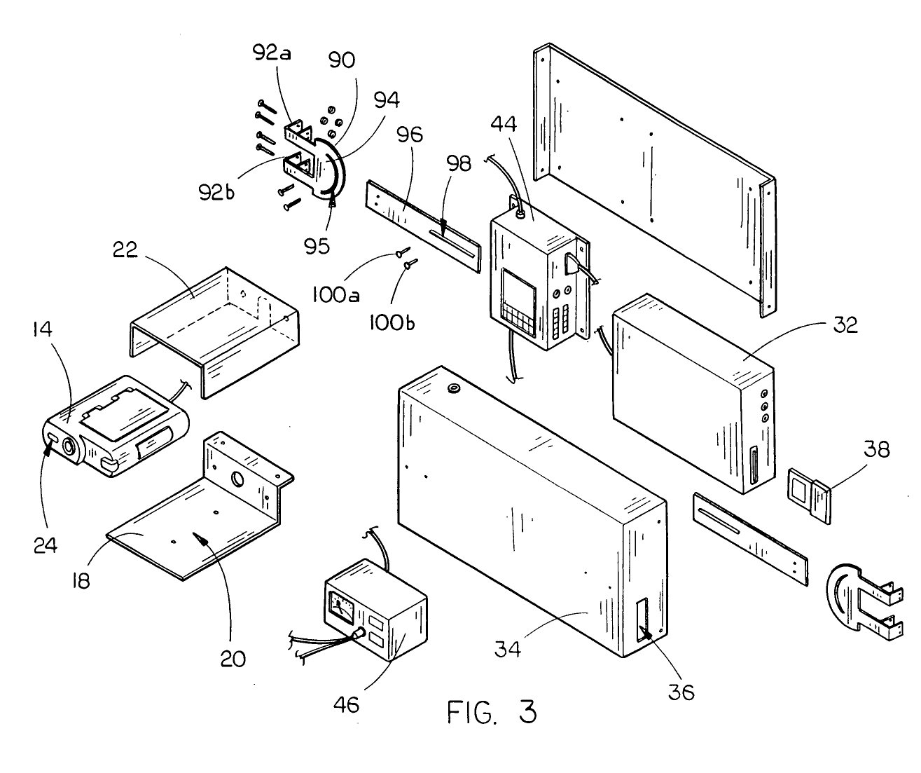

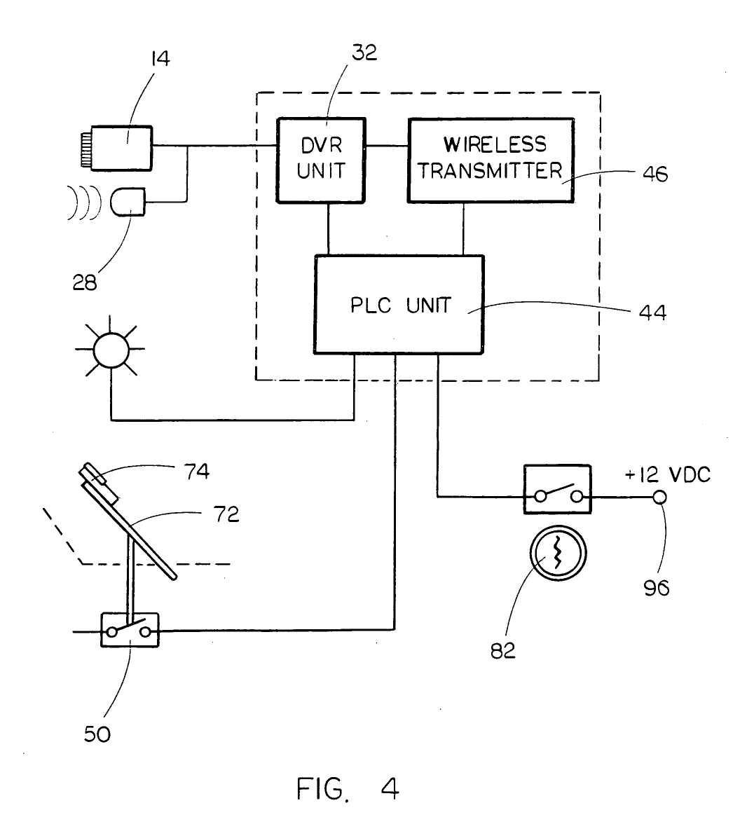

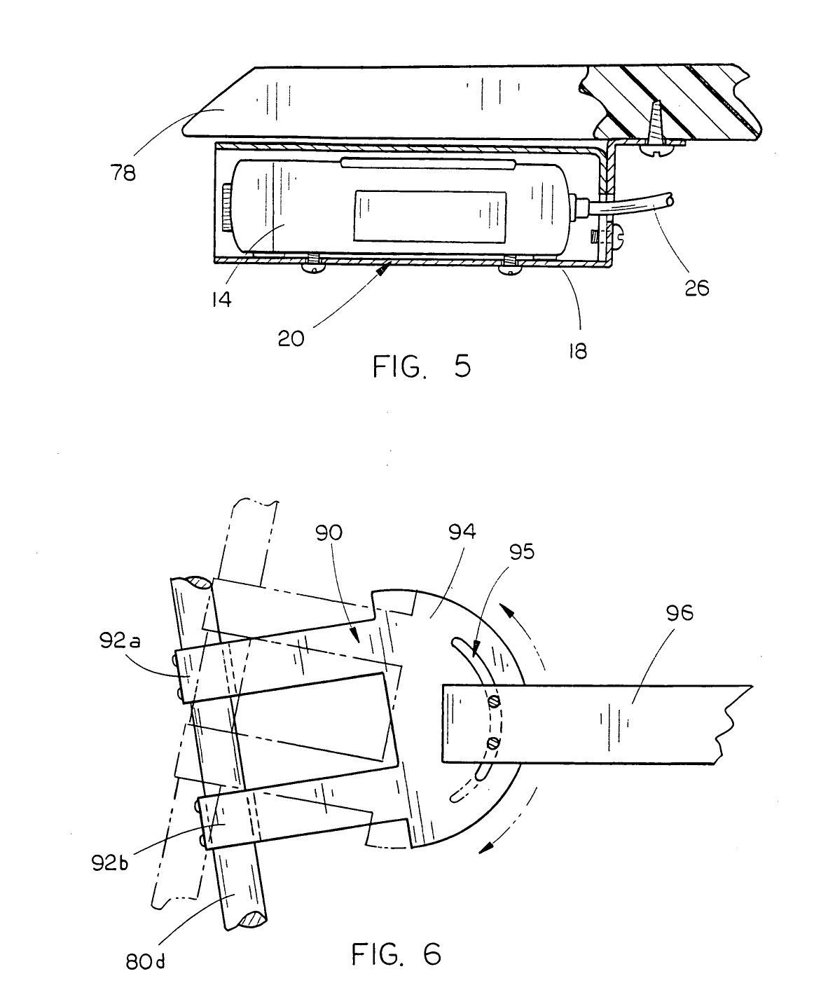

The video recording system 12 of the present invention is shown best in FIGS. 1-4 as including a digital video camera 14 which is adapted to be mounted on the golf cart 60, preferably on the roof 78 of the golf cart 60. As shown best in FIGS. 1, 3, and 5, the camera mounting structure 16 will preferably include a generally L-shaped mounting plate 18 which extends downwards and forwards from the roof 78, with the mounting plate 18 affixed to the roof 78 by a pair of bolts or the like to securely mount the mounting plate 18 on the roof 78. The camera mounting leg 20 of the mounting plate 18 supports the digital video camera 14, which is preferably bolted onto the camera mounting leg 20, and a protective housing 22 extends over and around the digital video camera 14 and is preferably welded to the camera mounting leg 20 of mounting plate 18, as shown best in FIGS. 3 and 4.

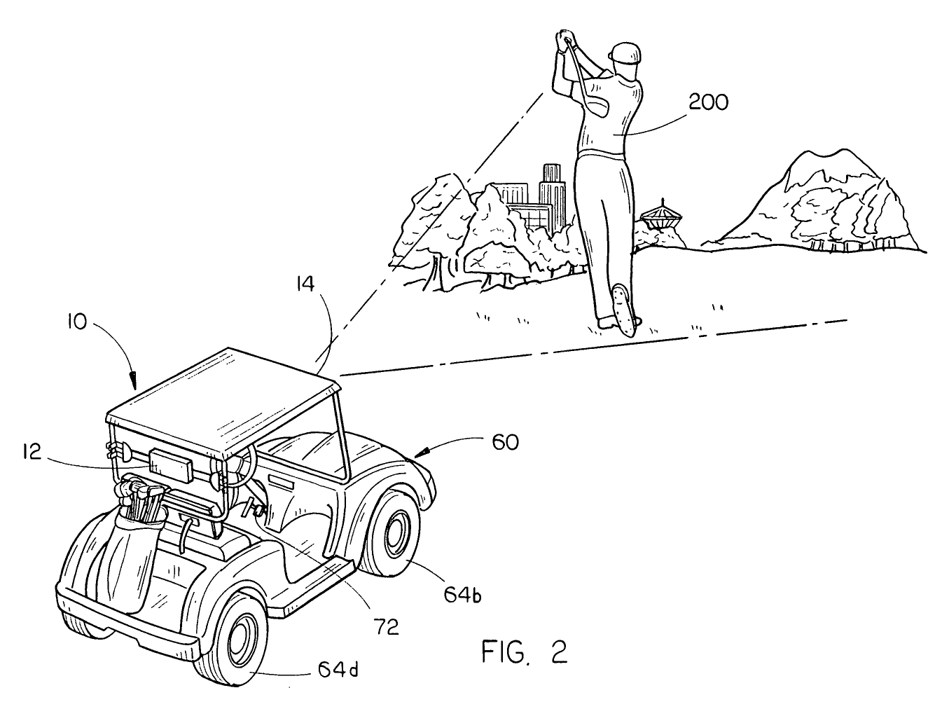

In the preferred embodiment, the digital video camera 14 would be of any appropriate type of video camera and would preferably include a wide angle lens having an aperture of approximately 2.9 millimeters which provides a horizontal feed between twenty and thirty yards and a vertical feed of between ten and twenty yards to ensure that the golfer 200 is within the field of view of the visual video camera 14 while he or she is taking the golf shot, as shown best in FIG. 2. Of course, the specific type of lens used in connection with the digital video camera 14 of the present invention is only critical in that the video image received by the digital camera 14 should be of sufficient quality to enable the teaching professional to review the recorded video and be able to discern various elements of the golfer's swing to provide teaching pointers to improve the fundamental techniques of the golfer.

It is further preferred that the digital video camera 14 face forwards from the golf cart 60 so that the operator of the golf cart need merely align the front of the golf cart with the position of his or her golf ball on the golf course in order to provide the proper field of view for the digital video camera 14, as shown in FIG. 2. However, there may be certain applications of the present invention which would require a different orientation of the digital video camera 14, and therefore the repositioning of the camera mounting structure 16 on the roof 78 or, in fact, anywhere on body 56 of golf cart 60 is contemplated herein. Also, it may be preferable to include a swivel or universal joint on which the digital video camera 14 is mounted to permit shifting of the field of view of the digital video camera 14, but in connection with the applications described herein, it is likely preferable that a fixed orientation for digital video camera 14 be used to reduce the responsibilities of the golfer in properly orientating the digital video camera 14 to record his or her shot.

In the preferred embodiment, the roof 78 of golf cart 60 would be supported by a plurality of roof support struts 80a, 80b, 80c, and 80d which would extend upwards from the body 66 to support the roof 78, as shown best in FIG. 1. It has been found that the rearmost roof support struts 80c and 80d provide an excellent location for mounting of the digital video recording device 32 of the video recording system 12 of the present invention. In the preferred embodiment, the digital video recording device 32 would be a mini digital audio/video recorder or DVR which is capable of recording both video and audio at VHS quality and at up to thirty frames per second, which is a sufficient number of frames per second to provide for video breakdown of the elements of the golfer's swing. Of course, the digital video recording device 32 may be of any appropriate type so long as it is capable of recording video images at a sufficient quality and rate to permit use of the video images by the teaching professional in reviewing the elements of the golfer's swing. The digital video recording device 32 would preferably be housed within a weather-tight enclosure box 34 which will protect the digital video recording device 32 housed there within. It is preferred, however, that the enclosure box 34 include an access slot 36 which permits the insertion and removal of a compact flash memory card 38 into the digital video recording device 32 to removably store the video and audio recorded by the digital video camera 14 thereon. Although the exact type of recordable media used in the present invention is not particularly critical to the proper functioning of the present invention, it has been found that the use of a compact flash memory card 38 provides a simple and efficient recordable media on which the video file recorded by the digital video recording device 32 may be saved. It is expected that the compact flash memory card 38 would be at least approximately one gigabyte in size in order to provide sufficient storage capacity for the video file recorded by the digital video recording device 32.

Extending between and connecting the digital video camera 14 and digital video recording device 32 is a video cable 26 which permits transfer of the video images from the digital video camera 14 to the digital video recording device 32. It is expected that the video cable 26 would be of any appropriate design so long as efficient transfer of the video images from the digital video camera 14 to the digital video recording device 32 is enabled. Also, it is preferred that the video cable 26 be extended along the roof 78 and down one of the two rearmost roof support struts 80c and 80d in order to safely and discretely run the video cable 26 between the digital video camera 14 and digital video recording device 32, although the specific route of the video cable 26 is not critical to the present invention.

Mounted within the weather-tight enclosure box 34 is a programmable logic control unit 44 which, in the preferred embodiment, would include activation software commands which are programmed into the unit 44 in the appropriate programming language as determined by the programmable logic control unit 44. It is the programmable logic control unit 44 which provides one of the most important operational features of the video recording system-equipped golf cart 10 of the present invention, specifically that the programmable logic control unit 44 controls engagement and disengagement of the digital video recording device 32 to record images from the digital video camera 14 at only certain times and in certain situations. The programmable logic control unit 44 is connected in operational engagement connection with the digital video recording device 32 and further includes a connection to a parking brake sensor 50 which is operative to determine whether the parking brake engagement section 74 of brake pedal 72 is in an engaged locked position or is disengaged to permit the golf cart 60 to move. In the preferred embodiment, the parking brake sensor 50 would be either a proximity switch which determines when the parking brake engagement section 74 of brake pedal 72 is closest to the floor of the golf cart 60 or would be a toggle switch type of sensor which detects when the parking brake engagement section 74 is locked in position to secure the brakes in locked position. Of course, the precise type of sensor used is not critical to the invention so long as the programmable logic control unit 44 can detect engagement and disengagement of the parking brake engagement section 74 of brake pedal 72.

The programmable logic control unit 44 would function in the following manner. The programmable logic control unit 44 polls the parking brake sensor 50 to determine if the parking brake engagement section 74 of brake pedal 72 has been lockably engaged to lock the brake system of the golf cart 60 and prevent movement of the golf cart 60. When the parking brake sensor 50 signifies that the parking brake engagement section 74 has been lockably engaged, the programmable logic control unit 44 initiates a delay timer which counts off a predetermined length of time prior to activating the digital video recording device 32 to record the video images being sent thereto from the digital video camera 14. In the preferred embodiment, this delay would be approximately ten to twenty seconds, as this is approximately the length of time needed by a golfer to stop the cart, exit the cart, select a golf club for the shot, and approach the golf ball prior to hitting it. The programmable logic control unit 44 then continues to poll the parking brake sensor 50 and when the parking brake sensor 50 signifies that the parking brake engagement section 74 of brake pedal 72 has been released, the programmable logic control unit 44 then stops the digital video recording device 32 from recording any further video from the digital video camera 14 until such time as the parking brake sensor 50 signifies that the parking brake engagement section 74 of brake pedal 72 has once again been lockably engaged.

The electrical power for the video recording system 12 of the present invention may be provided by a separate set of batteries, but it is preferred that the video recording system 12 be powered off of the battery system 76 of the golf cart 60, as shown best in FIGS. 1 and 2. The majority of golf carts 60 include an electrical power source, namely a rechargeable battery system 76, which provides power for the engine 68 of the golf cart 60. Several different battery systems 76 are used in connection with golf carts 60, and these may have different base voltages, including 12 volt, 24 volt, 36 volt, and 48 volt battery systems. It is therefore necessary to include a voltage converter unit 54 which is interposed between the battery system 76 of golf cart 60 and the programmable logic control unit 44, digital recording device 32, and digital video camera 14 of the video recording system 12, as shown in FIG. 1. In the preferred embodiment, the voltage converter unit 54 would convert and reduce the voltage to the appropriate voltage necessary to power the various elements of the video recording system 12, and such voltage reduction and conversion devices are known in the prior art. The power would then be fed to the various elements of the video recording system 12 via a power cable 56. However, it is further preferred that the voltage converter unit 54 be of high-quality and sturdy construction to withstand the various jolts and bumps encountered during operation of the golf cart 60, as a measured and exact voltage output from the voltage converter unit 54 is necessary for proper operation of the video recording system 12. It is further expected that the power source for the video recording system 12 would be engaged via operation of the power system for the golf cart 60, and hence when the ignition or activation key 82 is engaged to permit operation of the golf cart 60, the video recording system 12 would also be activated.

An additional structural feature of the present invention is that the weather-tight enclosure box 34, in being mounted on the roof support struts 80c and 80d, will likely require an adjustable mounting bracket 90 which will accommodate the specific offset angle of the roof support struts 80c and 80d, as there are many different roof designs which are used in connection with golf cart 60 and the roof support struts 80a-d used in connection with support of the roof 78 extend at various angles from the body 56 upwards to the roof 78. To accommodate these angles, the mounting bracket 90 would preferably include a pair of strut connection brackets 92a and 92b which would extend around the roof support strut 80c and are connected to a semi-circular bracket connection plate 94 on which enclosure box mounting plate 96 is adjustably mounted. The semi-circular bracket connection plate 94 would preferably include an arcuate slot 95 on which enclosure box mounting plate 96 may be slid in order to adjust the alignment of enclosure box mounting plate 96 relative to the roof support strut 80c on which the mounting bracket 90 is mounted. Finally, enclosure box mounting plate 96 would also include a longitudinally extended slot 98 through which mounting bolts 100a and 100b may be extended to securely mount the weather-tight enclosure box 34 thereon. In this manner, the weather-tight enclosure box 34 may be securely connected to the roof support struts 80c and 80d regardless of the angle at which the roof support struts 80c and 80d extend upwards. It is further expected that each of the elements of the mounting bracket 90 will be constructed of plastic or metal for durability.

An additional feature of the present invention is that the programmable logic control unit 44 may also be connected to a wireless transmitter 46 which will permit the video file to be quickly and easily uploaded to a designated receiving computer which can then be accessed by the authorized teaching professional or other employee of the golf course. Many different types of wireless transmitters 46 are known for use with transmission of such video files, and it is believed that any appropriate wireless transmitter 46 may be incorporated into the video recording system 12 of the present invention so long as the efficient and accurate transfer of the video file information is permitted.

The video recording system-equipped golf cart 10 of the present invention would be used in the following manner, as shown best in FIG. 2. The operator of the golf cart 60 would drive the golf cart 60 to the location where his or her golf ball is resting and aim the forward end of the golf cart 60 at the golf ball location, thus aligning the digital video camera 14 with the location of the golf ball. He or she would then engage the parking brake engagement section 74 of brake pedal 72 which would activate the parking brake sensor 50 to signify to programmable logic control unit 44 that the parking brake has been engaged. The programmable logic control unit 44 would then start the delay timer while the golfer 200 was deciding on which club to use to hit the golf ball, and then as the golfer 200 approaches the golf ball, the digital video recorder device 32 would be activated by the programmable logic control unit 44 to begin recording video images sent from the digital video camera 14. An indicator light 24 positioned adjacent or on the digital video camera 14 will signify to the golfer 200 that the system is actively recording, and then the golfer 200 may simply hit the golf shot when he or she is ready to do so. After hitting the golf shot, the golfer 200 would then return to the golf cart 60 and disengage the parking brake engagement section 74 of brake pedal 72, which is noted by parking brake sensor 50 which passes the information along to the programmable logic control unit 44. The programmable logic control unit 44 then commands the digital video recording device 32 to stop recording until the next time the parking brake is engaged.

It is seen that the video recording system 12 of the video recording system-equipped golf cart 10 of the present invention could not be simpler or easier for a golfer to use. Merely by driving the golf cart 60 in a standard manner, the golfer can obtain a video recording of virtually the entire round of golf he or she has played. This video file can then be transferred on the compact flash memory card 38 or via the wireless transmitter 46 to a receiving computer which can then be operated by the teaching professional or other employee of the golf course to review and critique each and every shot taken by the golfer during the round of golf. Also, an important feature not yet discussed in connection with the present invention is that the video record of the round of golf played by the golfer can be obtained and saved by the golfer to provide a video memory of the golf experience. There are many beautiful and challenging courses found the world over, and it is an unfortunate by-product of the game of golf that very often all a golfer has to take with himself or herself at the end of the round of golf are his or her memories. However, by using the video recording system 12 of the present invention, the golfer may obtain a full video record of his or her round of golf which can then be transferred to a DVD or other such recordable media to provide a permanent record of that day's outing. It is thus seen that the present invention provides many features which will enhance the golfing experience for the golfer while also permitting a teaching professional to review each and every shot from a round of golf to provide a significantly improved level of service and assistance to the golfer.

It is to be understood that numerous additions, modifications, and substitutions may be made to the video recording system-equipped golf cart 10 of the present invention which fall within the intended broad scope of the appended claims. For example, although the elements and structural materials of the video recording system 12 and golf cart 60 of the present invention have been described with some particularity, substitution of other devices for those described herein is understood to be a part of this disclosure so long as the substitution does not materially degrade the performance characteristics of the video recording system 12 or the golf cart 60. Also, although the digital video camera 14 has been described as sending a video image feed to the digital video recording device 32, it is quite common that the digital video camera 14 would also include a microphone 28 which will provide an recordable audio feed to the digital video recording device 32, and it may be found that the use of the microphone 28 will provide additional information for the teaching professional to determine how best to correct flaws in the golfer's swing. Furthermore, although the present invention has been described as being used in connection with review and critique of golfers, it should be quite clear that the video recording system-equipped golf cart 10 of the present invention is suitable for numerous applications, including use with sporting events, in entertainment venues, construction operations, and in marine operations where golf carts 60 are used for transportation purposes. The inclusion of the video recording system 12 on the golf cart 60 will add video recording capability to the golf cart 60 which will likely be found to be quite handy when used in connection with the above-mentioned applications. Finally, the combination of the fixed position of the digital video camera 14 and the inability of the digital video recording device 32 to function unless the parking brake engagement section 74 of brake pedal 72 is engaged will act to restrict unauthorized video recording of inappropriate subject matter, and such use will be further discouraged by the fact the golfer may be prevented from accessing the compact flash memory card 38 if the wireless transmitter 46 is being used. As the golfer cannot access the video without working with an authorized agent of the golf course, he or she will be much more likely to use the video recording system 12 of the present invention in an appropriate manner as opposed to those devices found in the prior art.

There has therefore been shown and described a video recording system-equipped golf cart 10 which accomplishes at least all of its intended objectives.

I claim:

1. A video recording system-equipped golf cart comprising:
a golf cart including at least a chassis, ground-engaging wheels rotatably mounted on said chassis, a body mounted on said chassis, engine means operative to power said golf cart, steering means operatively connected to said ground-engaging wheels and releasably locking brake pedal means mounted on said golf cart and operatively connected to brakes which engage said ground-engaging wheels to slow said golf cart and is then releasably lockable to secure said golf cart in a stopped position;
a video recording system including;
digital video camera means mounted on said golf cart and facing outwards therefrom, said digital video camera means operative to receive video images therein;
digital video recording means mounted on said golf cart, said digital video recording means operative to receive and record video images on recordable digital media therein;
said digital video recording means in information transmission connection with said digital video camera means for transfer of video images from said digital video camera means to said digital video recording means;
a programmable logic controller device in information transmission connection with said digital video recording means and said brake pedal means of said golf cart, said programmable logic controller device operative to initiate operation of said digital video recording means upon said brake pedal means being locked to secure said golf cart in a stopped position and further operative to prevent operation of said digital video recording means upon said brake pedal means being released from locked position whereby said digital video recording system is inoperative when said golf cart is not stopped;
power supply means in power transmission connection with said digital video camera means, said digital video recording means and said programmable logic controller device for providing operating power to said digital video camera means, said digital video recording means and said programmable logic controller device; and
said video recording system operative to obtain a video image record of event occurrences around said golf cart such as golf player swings and shots for future playback and review of said video image record to enhance and assist training for golfers using said video recording system-equipped golf cart.

2. The video recording system-equipped golf cart of claim 1 wherein said digital video recording means comprises a mini digital audio/video recorder capable of recording both video and audio at least at VHS quality.

3. The video recording system-equipped golf cart of claim 1 wherein said digital video camera means comprises a digital video camera having a wide angle lens having an aperture of approximately 2.9 millimeters whereby said digital video camera provides a horizontal feed between twenty and thirty yards and a vertical feed of between ten and twenty yards.

4. The video recording system-equipped golf cart of claim 1 wherein said programmable logic controller device includes software programming to drive said programmable logic controller device.

5. The video recording system-equipped golf cart of claim 1 wherein said releasably locking brake pedal means further comprises a parking brake engagement section operative to lock said brake pedal means in a depressed position to engage the brakes of the golf cart to lock the ground-engaging wheels to generally prevent forward or rearward motion of the golf cart.

6. The video recording system-equipped golf cart of claim 5 further comprising a parking brake sensor in information transmission connection with said programmable logic controller device operative to determine whether said parking brake engagement section of said brake pedal is in an engaged locked position or is disengaged to permit said golf cart to move.

7. The video recording system-equipped golf cart of claim 1 wherein said recordable digital media of said digital video recording device comprises a compact flash memory card insertable into and removable from said digital video recording device to removably store the video and audio recorded by said digital video camera thereon.

8. The video recording system-equipped golf cart of claim 7 wherein said digital video recording device is housed within a weather-tight enclosure box operative to protect said digital video recording device housed therewithin, said enclosure box further including an access slot operative to permit the insertion and removal of said compact flash memory card into said digital video recording device to removably store the video and audio recorded by said digital video camera thereon.

9. A video recording system for a golf cart having releasably locking brake pedal means mounted on the golf cart and operatively connected to brakes which engage the wheels to slow the golf cart and then is releasably lockable to secure the golf cart in a stopped position, said video recording system comprising:
digital video camera means mountable on the golf cart and facing outwards therefrom, said digital video camera means operative to receive video images therein;
digital video recording means mountable on the golf cart, said digital video recording means operative to receive and record video images on recordable digital media therein;
said digital video recording means in information transmission connection with said digital video camera means for transfer of video images from said digital video camera means to said digital video recording means;
a programmable logic controller device in information transmission connection with said digital video recording means and adapted to discern operation of the brake pedal means of the golf cart, said programmable logic controller device operative to initiate operation of said digital video recording means upon detection of the brake pedal means being locked to secure the golf cart in a stopped position and further operative to prevent operation of said digital video recording means upon the brake pedal means being released from locked position whereby said digital video recording system is inoperative when the golf cart is not stopped;
power supply means in power transmission connection with said digital video camera means, said digital video recording means and said programmable logic controller device for providing operating power to said digital video camera means, said digital video recording means and said programmable logic controller device; and
said video recording system operative to obtain a video image record of event occurrences around the golf cart on which said video recording system is mounted such as golf player swings and shots for future playback and review of said video image record to enhance and assist training for golfers.

10. The video recording system for a golf cart of claim 9 wherein said digital video recording means comprises a mini digital audio/video recorder capable of recording both video and audio at least at VHS quality.

11. The video recording system for a golf cart of claim 9 wherein said digital video camera means comprises a digital video camera having a wide angle lens having an aperture of approximately 2.9 millimeters whereby said digital video camera provides a horizontal feed between twenty and thirty yards and a vertical feed of between ten and twenty yards.

12. The video recording system for a golf cart of claim 9 wherein said programmable logic controller device includes software programming to drive said programmable logic controller device.

13. The video recording system for a golf cart of claim 9 further comprising a parking brake sensor in information transmission connection with said programmable logic controller device operative to determine whether the brake pedal is in an engaged locked position or is disengaged to permit the golf cart to move.

14. The video recording system for a golf cart of claim 9 wherein said recordable digital media of said digital video recording device comprises a compact flash memory card insertable into and removable from said digital video recording device to removably store the video and audio recorded by said digital video camera thereon.

15. The video recording system for a golf cart of claim 14 wherein said digital video recording device is housed within a weather-tight enclosure box operative to protect said digital video recording device housed therewithin, said enclosure box further including an access slot operative to permit the insertion and removal of said compact flash memory card into said digital video recording device to removably store the video and audio recorded by said digital video camera thereon.

16. The video recording system for a golf cart of claim 9 further comprising an adjustable mounting bracket which includes a pair of strut connection brackets operative to extend around opposite roof support struts of a golf cart, each strut connection bracket connected to a generally semi-circular bracket connection plate on which an enclosure box mounting plate is adjustably mounted, said semi-circular bracket connection plate including an arcuate slot formed therein in which said enclosure box mounting plate may be adjustably slid in order to adjust the alignment of said enclosure box mounting plate relative to the roof support struts on which said mounting brackets are mounted, said enclosure box mounting plates also including a longitudinally extended slot through which at least one mounting bolt is extendable to mount the weather-tight enclosure box thereon.

17. A video recording system-equipped golf cart comprising:
a golf cart including at least a releasably locking brake pedal means mounted on said golf cart and operatively connected to brakes which engage wheels to slow said golf cart and is then releasably lockable to secure said golf cart in a stopped position;
a video recording system including;
digital video camera means mounted on said golf cart and facing outwards therefrom, said digital video camera means operative to receive video images therein;
digital video recording means mounted on said golf cart, said digital video recording means operative to receive and record video images on recordable digital media therein;
said digital video recording means in information transmission connection with said digital video camera means for transfer of video images from said digital video camera means to said digital video recording means;
a programmable logic controller device in information transmission connection with said digital video recording means and said brake pedal means of said golf cart;
a parking brake sensor in information transmission connection with said programmable logic controller device operative to determine whether said brake pedal means is in an engaged locked position or is disengaged to permit said golf cart to move;
said programmable logic controller device operative to initiate operation of said digital video recording means upon said parking brake sensor identifying and signaling locking of said brake pedal means to secure said golf cart in a stopped position and further operative to prevent operation of said digital video recording means upon said brake pedal means being released from locked position whereby said digital video recording system is inoperative when said golf cart is not stopped;
power supply means in power transmission connection with said digital video camera means, said digital video recording means and said programmable logic controller device for providing operating power to said digital video camera means, said digital video recording means and said programmable logic controller device; and
said video recording system operative to obtain a video image record of event occurrences around said golf cart such as golf player swings and shots for future playback and review of said video image record to enhance and assist training for golfers.
